(19) United States
(12) Patent Application Publication
(10) Pub. No.: US 2026/0118180 A1
(43) Pub. Date: Apr. 30, 2026

(54) HIGH-SPEED TEMPERATURE MEASUREMENT METHOD AND HIGH- SPEED TEMPERATURE MEASUREMENT DEVICE

(71) Applicant: SEMES CO., LTD., Cheonan-si (KR)

(72) Inventors: Sang Hyun SON, Cheonan-si (KR); Yong Eun JEON, Cheonan-si (KR); Sang Min HA, Cheonan-si (KR); Yong Jun SEO, Cheonan-si (KR); Jin Hee HONG, Cheonan-si (KR); Hyeong Jun CHO, Cheonan-si (KR)

(73) Assignee: SEMES CO., LTD., Cheonan-si (KR)

(21) Appl. No.: 19/004,419

(22) Filed: Dec. 29, 2024

(30) Foreign Application Priority Data
Dec. 29, 2023 (KR) 10-2023-0197373

(51) Int. Cl. G01J 5/00; G01J 5/08; G01J 5/0803

(52) U.S. Cl. CPC G01J 5/0007; G01J 5/0803; G01J 5/0896

(57) ABSTRACT

Proposed is an optical-based high-speed temperature measurement method and a high-speed temperature measurement device, wherein the method includes heating a substrate with a heat source, emitting a measured light to the substrate and providing an original wavelength signal of the measured light to a processing device, receiving a reflected optical signal of the measured light to provide the same to the processing device as a reflected wavelength signal, and calculating a temperature change of the substrate, and the device includes a measurement laser unit for emitting the measured light to the substrate in order to monitor the temperature change of the substrate, a detection unit for detecting an optical signal by the measurement laser unit, and a high-speed signal processing unit for outputting data on the temperature change of the substrate by using the optical signal detected by the detection unit.

### CROSS REFERENCE TO RELATED APPLICATION

The present application claims priority to Korean Patent Application No. 10-2023-0197373, filed on Dec. 29, 2023, the entire contents of which are incorporated herein for all purposes by this reference.

### BACKGROUND

### Technical Field

The present disclosure relates to an optical-based high-speed temperature measurement method and a high-speed temperature measurement device.

### Description of the Related Art

In facilities where semiconductor chips are manufactured and inspected under a variety of environmental conditions, it is important to ensure a uniform process temperature distribution over a wide range. In order to ensure such a uniform temperature distribution to be formed, accurate temperature measurement is required.

For example, a substrate in a process of the substrate heat treatment may be introduced into a high-speed heat treatment device and exposed to a pulsed optical beam during the process. In this case, the surface of the area exposed to the pulsed optical beam may be heated to a high temperature of 1000° C. or higher for a short period of time lasting less than 1 ms or less than 1 μs.

The high temperature causes structural changes in the area exposed to the pulsed optical beam. The extent of the structural changes is dependent on the temperature, so it is important to quickly and accurately monitor the temperature while the heat treatment process is being performed.

In a situation where a rising curve of the temperature changing at high speed cannot be accurately tracked, it is not possible to control a heat source and optimize a process. In order to optimize the process, it is necessary to track a temperature graph with steeply changing trends, but conventional temperature measurement devices and methods use a thermal radiation or thermocouple method, which only has ms-level reactivity, and even this may be further delayed depending on the heat capacity of the sensor. As an alternative for this, an optical thermometer using wavelength emissivity has been proposed, but in the case of the optical thermometer, it is difficult to track the rising curve of the temperature because it takes a long time in the process of measuring precisely and densely physical quantities such as emissivity, reflectivity, transmittance, and the like by identifying the corresponding wavelength, and of converting the same into the temperature. Therefore, it is necessary to have a device capable of precisely measuring the change in emissivity according to the temperature of the substrate and a device implementing high-speed signal processing technology capable of converting the measured change in emissivity at a speed suitable for the temperature change trend.

### SUMMARY

The present disclosure is to provide a high-speed temperature measurement method and a high-speed temperature measurement device, which is capable of measuring and outputting surface temperature changes of a rapidly changing target material with high accuracy.

In addition, the present disclosure is to provide a high-speed temperature measurement method and a high-speed temperature measurement device, which includes a high-speed signal processing device capable of converting a change in emissivity into a temperature at a response time of ns (nanoseconds).

In addition, the present disclosure is to provide a high-speed temperature measurement method and a high-speed temperature measurement device, which is capable of predicting temperature changes of a substrate caused by a heat source by using a pulse timing of the heat source that heats the substrate.

Tasks to be solved by the present disclosure are not limited to the tasks described above, and tasks not mentioned can be clearly understood by those skilled in the art to which the present disclosure pertains from the present specification and the accompanying drawings.

According to an exemplary embodiment of the present disclosure, there is provided a high-speed temperature measurement method, which includes heating a substrate with a heat source, emitting a measured light to the substrate and providing an original wavelength signal of the measured light to a processing device, receiving a reflected optical signal of the measured light reflected from the substrate to provide the same to the processing device as a reflected wavelength signal, and calculating a temperature change of the substrate caused by the heat source by comparing the original wavelength signal and the reflected wavelength signal.

In an exemplary embodiment, calculating the temperature change of the substrate may be performed on the basis of a change in reflectivity of the measured light.

In an exemplary embodiment, the method may further include synchronizing the original wavelength signal and the reflected wavelength signal by adjusting a path length of an optical wave of the original wavelength signal and the reflected wavelength signal.

In an exemplary embodiment, the method may further include providing a heating start signal of the heat source to the processing device, and predicting a temperature change of the substrate caused by the heat source by using the heating start signal.

In an exemplary embodiment, an offset reflecting a difference of a measurement time may be set on the basis of the heating start signal, and the set offset may be applied to correcting a timing of measuring the temperature of the substrate.

In an exemplary embodiment, the method may further include receiving a transmitted optical signal of the measured light penetrating through the substrate to provide the same to the processing device as a transmitted wavelength signal, and calculating a temperature change on a lower surface of the substrate by comparing the original wavelength signal and the transmitted wavelength signal.

According to an exemplary embodiment of the present disclosure, there is provided a high-speed temperature measurement device, which includes a measurement laser unit for emitting a measured light to a substrate in order to monitor a temperature change of the substrate while the substrate is heated by a heat source, a detection unit for detecting an optical signal by the measurement laser unit, and a high-speed signal processing unit for outputting data on the temperature change of the substrate by using the optical signal detected by the detection unit.

In an exemplary embodiment, the high-speed signal processing unit may include an optical signal receiving part for receiving the optical signal and converting the received optical signal into an analog data, an A/D converting part for converting the analog data into a digital data according to a sampling period, an optical signal processing part for detecting a wavelength change on the basis of the digital data and storing a sampled code value, a temperature converting part for converting the wavelength change into a temperature value on the basis of a temperature model compared to an optical wave change, a data storage and transceiver part for storing and transmitting data on the temperature value, and a process part for controlling the optical signal receiving part, the A/D converting part, the optical signal processing part, the temperature converting part, and the data storage and transceiver part.

In an exemplary embodiment, the measurement laser unit may include an optical coupler for separating the measured light into a reference light and an incident light, and an optical circulator for outputting a reflected light of the incident light reflected from the substrate to the detection unit, wherein the detection unit includes a first detection member for detecting the reference light of the measured light as an original wavelength signal, and a second detection member for detecting the reflected light of the incident light reflected from the substrate as a reflected wavelength signal, or a third detection member for detecting a transmitted light of the measured light penetrating through the substrate as a transmitted wavelength signal.

In an exemplary embodiment, the optical signal receiving part may receive the original wavelength signal of the measured light, and receive at least one of the reflected wavelength signal and the transmitted wavelength signal of the measured light.

In an exemplary embodiment, the optical signal processing part may derive a reflectivity or transmittance of the substrate on the basis of the data received by the optical signal receiving part, and may sample a wavelength change for the reflectivity or transmittance of the substrate.

In an exemplary embodiment, the optical signal received by the optical signal receiving part may further include a heating start signal caused by the heat source.

In an exemplary embodiment, the A/D converting part may receive the heating start signal and convert data according to the heating start signal, and the optical signal processing part may set an offset value for correcting a measurement timing by using the data converted according to the heating start signal.

In an exemplary embodiment, the process part may correct the timing of measuring the temperature of the substrate by applying the offset value.

According to an exemplary embodiment of the present disclosure, there is provided a substrate processing device, which includes a chamber for providing a processing space, a substrate support unit for supporting a substrate in the processing space, a heating unit including a heat source for heating the substrate, and a high-speed temperature measurement device for measuring at high speed a temperature change of the substrate caused by the heat source. The high-speed temperature measurement device may include a measurement laser unit for emitting a measured light to the substrate in order to monitor the temperature change of the substrate while the heating unit heats the substrate, a detection unit for detecting an optical signal by the measurement laser unit, and a high-speed signal processing unit for outputting data on the temperature change of the substrate by using the optical signal detected by the detection unit.

According to an exemplary embodiment of the present disclosure, it is possible to measure and output surface temperature changes of a rapidly changing target material with high accuracy by a high-speed temperature measurement device, which includes a high-speed signal processing device capable of converting a change in emissivity into a temperature at a response time of ns (nanoseconds).

In addition, by using a pulse timing of a heat source, it is possible to predict the temperature change of the substrate caused by the heat source, whereby the measurement accuracy is improved by setting and applying an offset for the measurement timing.

The effects of the present disclosure are not limited to the effects described above, and other effects not mentioned can be clearly understood by those skilled in the art to which the present disclosure pertains from the present specification and the accompanying drawings.

### BRIEF DESCRIPTION OF THE DRAWINGS

FIG. 1 is a view showing the configuration of a substrate processing device according to an exemplary embodiment of the present disclosure.

FIG. 2 is a view showing the configuration of a substrate processing device according to another exemplary embodiment of the present disclosure.

FIG. 3 is a view for explaining the configuration of high-speed signal processing units of FIGS. 1 and 2.

FIG. 4 is a view showing an example of a change in reflectivity over time.

FIGS. 5A and 5B are views for explaining an offset correction according to the present disclosure.

### DETAILED DESCRIPTION OF THE DISCLOSURE

Hereinafter, exemplary embodiments of present the disclosure will be described in detail with reference to the accompanying drawings so that those skilled in the art to which the present disclosure pertains may easily implement the present disclosure. The present disclosure may be implemented in various different forms and is not limited to the exemplary embodiments described herein.

In order to clearly describe the present disclosure, parts irrelevant to the description may be omitted, and the same reference numerals may be used for identical or similar components throughout the specification.

In addition, in various exemplary embodiments, components having the same configuration will be described only in representative exemplary embodiments using the same reference numerals, and in other exemplary embodiments, only configurations different from representative exemplary embodiments will be described.

Throughout the specification, when a part is “connected (or combined)” to another part, this may include not only the case where it is “directly connected (or combined)” but also the case where it is “indirectly connected (or combined)” to another member therebetween. In addition, when a part “includes” a component, this does not mean that it excludes other components, but rather that it can include other components, unless specifically stated otherwise.

Unless otherwise defined, all terms used herein, including technical or scientific terms, may have the same meaning as is generally understood by those skilled in the art to which the present disclosure pertains. Terms such as those generally defined in the dictionary should be interpreted as having a meaning consistent with the meaning of the context of the relevant technology and may not be interpreted in an ideal or overly formal sense unless explicitly defined in this application.

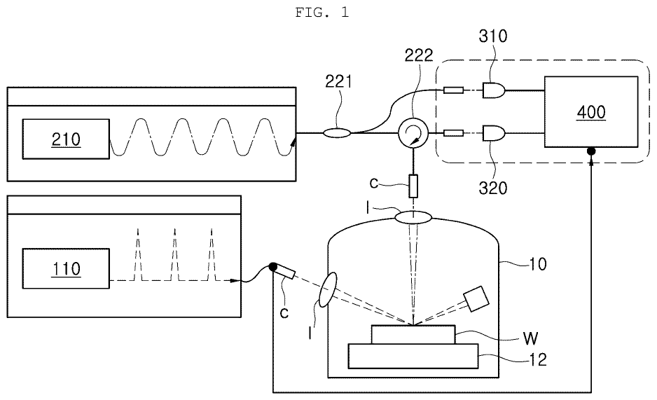

FIG. 1 is a view schematically showing the configuration of a substrate processing device including a high-speed temperature measurement device according to an exemplary embodiment of the present disclosure.

The high-speed temperature measurement device according to the present disclosure may be applied to semiconductor manufacturing processes. More specifically, the high-speed temperature measurement device according to the present disclosure may be a device for measuring a surface temperature of a substrate that is heat-treated by a rapid thermal source. Accordingly, the target material for measuring the surface temperature may be the substrate (W). The substrate (W) may, for example, be a wafer. The substrate may typically be, for example, a silicon wafer or a composite wafer commonly used in the semiconductor device industry. The substrate may be heat-treated while being placed inside a process chamber configured for heat treatment.

The high-speed temperature measurement device according to an exemplary embodiment of the present disclosure may use a technique of measuring the surface temperature of the target material by using the reflectivity recovered from the surface of the target material whose temperature is to be measured or by using the transmittance penetrating through the target material.

The vibrational motion of the particles (atoms) constituting the solid crystal may cause thermal expansion since the available volume of the particles increases due to the increase in vibrational energy as the temperature increases. In addition, when the temperature increases in the same unit volume, the polarizability of the particles may also increase (related to the complex permittivity). Therefore, the thermal expansion and polarizability changes according to the temperature may be considered to affect the refractive index, reflectivity, and transmittance when the optical source is injected, so the relationship therebetween may be utilized.

Referring to FIG. 1, the substrate processing device according to the present disclosure may include a chamber 10 for providing a processing space, a substrate support unit 12 for supporting the substrate (W) inside the processing space, a heating laser unit for heating the substrate (W), and a high-speed temperature measurement device, wherein the high-speed temperature measurement device includes a measurement laser unit, a detection unit, and a high-speed signal processing unit 400.

The heating unit may include a heat source 110 for heating the substrate (W) and a first optical system for forming a path of a wavelength emitted from the heat source 110.

The heat source 110 may be provided as a high-speed heat generation source for generating a pulse wave. For example, the heat source 110 may be provided as ns/ps/fs pulse laser/microwave. The frequency of the wavelength by the heat source 110 may be set differently depending on the configuration and measurement method of the heat source 110.

The first optical system may be configured to form the path of the pulse wave emitted from the heat source 110, and the pulse wave by the heat source 110 may be incident onto the substrate W. The first optical system may include at least one focusing member (c) for focusing the pulse wave on the surface of the substrate (W), and at least one more lens member (l) for providing an appropriate direction to the pulse wave. If necessary, the lens member (l) may be replaced with a mirror member.

The measurement laser unit may radiate the measured light onto the substrate heated by the heat source 110 in order to measure the temperature change of the substrate (W) caused by the heating laser unit.

The measurement laser unit may include a measurement laser 210 and a second optical system for forming an optical path of the measured light.

The measurement laser 210 may be a continuous-wave (CW) laser that generates a continuous wave. In order to improve the temperature consistency of the measured result value, it may be preferable that the measurement laser has a wavelength range with a high reflectivity for the measurement material, i.e., the substrate (W). In addition, it may be preferable to have high optical power in consideration of the optical power loss caused by components that process the reflected light. In addition, it may be better when the relative intensity noise (RIN %) is low or the noise filtering is easy. The frequency of the measured light may be set differently depending on the configuration of the heating laser 110 and the measurement method.

The second optical system may be configured to form the optical path of the measured light, such that an area of the substrate (W) where the measured light reaches is the same as an area of the substrate (W) where the wavelength by the heat source 110 reaches. The second optical system may include at least one focusing member (c) for focusing the measured light on the surface of the substrate (W) and at least more than one lens member (l) for providing the appropriate direction for the measured light. If necessary, the lens member (l) may be replaced with the mirror member.

The second optical system may include an optical coupler 221 for separating the measured light into the reference light and the incident light, and an optical circulator 222 for outputting to the detection unit the reflected light of the measured light reflected from the substrate (W). The optical coupler 221 and the optical circulator 222 may be replaced with any device having the same effect.

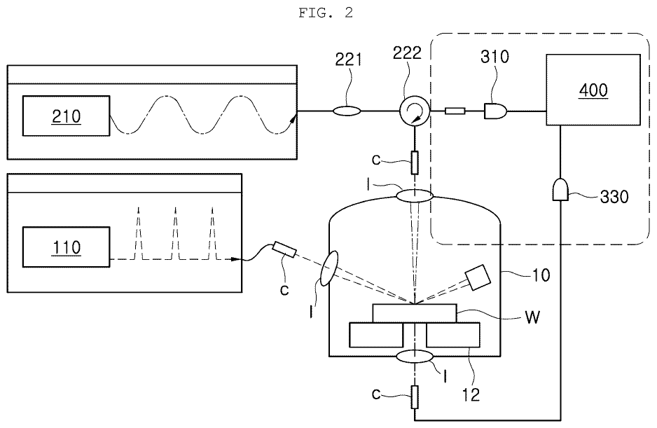

The detection unit may include a first detection member 310 for detecting the reference light of the measured light as an original wavelength signal, and at least one of a second detection member 320 for detecting the reflected light of the incident light reflected from the substrate (W) as the reflected wavelength signal and a third detection member 330 for detecting the transmitted light of the incident light penetrating through the substrate (W) as the transmitted wavelength signal. FIG. 1 is a view showing an example of a substrate processing device including the second detection member 320, and FIG. 2 is a view showing an example of a substrate processing device including the third detection member 330.

Using the substrate processing device of FIG. 1, the temperature change of the substrate may be measured on the basis of the change in reflectivity, and using the substrate processing device of FIG. 2, the temperature change of the substrate may be measured on the basis of the change in transmittance.

The first detection member 310 may detect the intensity of the reference light, the second detection member 320 may detect the intensity of the reflected light, and the third detection member 330 may detect the intensity of the transmitted light. As an example, the detection unit may include, as the detection member, a photodiode (PD) that detects the intensity of the light as a voltage signal.

The detection unit may transmit a detection value by each detection member to the high-speed signal processing unit 400.

The detection value by the detection unit may be transmitted to the high-speed signal processing unit 400 through a channel connected to the high-speed signal processing unit 400. For example, the detection value by the first detection member 310 may be transmitted to the high-speed signal processing unit 400 through a channel 1 (ch. 1), and each detection value by the second detection member 320 or the third detection member 330 may be transmitted to the high-speed signal processing unit 400 through a channel 2 (ch. 2).

The high-speed signal processing unit 400 may calculate the temperature of the substrate (W) by identifying the difference between the signals coming into each channel, and may perform compensation by comparing the original wavelength signal and the reflected wavelength signal/transmitted wavelength signal in order to identify the minute periodic change of the signal and the signal intensity change. In addition, by performing a design that the path length of the optical wave divided into two by the optical coupler 221 is calculated and the signals through each channel simultaneously reach the high-speed signal processing unit 400, the two signals may be simply synchronized, and interference factors in high-speed signal processing may be eliminated by easily and quickly removing the noise components contained in the measured light.

The high-speed signal processing unit 400 may be capable of deriving data on the temperature change of the substrate (W) by using the optical signal detected by the detection unit. More specifically, the high-speed signal processing unit 400 may calculate the reflectivity of the substrate (W) on the basis of the detection value of the second detection unit 320, and calculate the surface temperature of the substrate (W) from the calculated reflectivity. Alternatively, the high-speed signal processing unit 400 may calculate the transmittance of the substrate (W) on the basis of the detection value of the third detection unit 330, and calculate the temperature of the lower surface of the substrate (W) from the calculated transmittance.

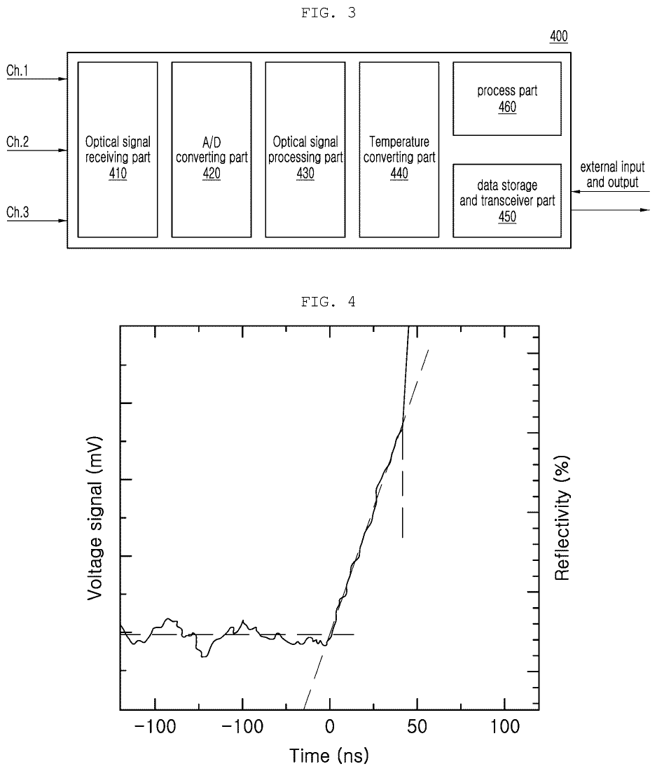

FIG. 3 is a view for explaining the configuration of a high-speed signal processing unit 400 referring to FIG. 3, the high-speed signal processing unit 400 may include an optical signal receiving part 410, an A/D converting part 420, an optical signal processing part 430, a temperature converting part 440, a data storage and transceiver part 450, and a process part.

The optical signal receiving part 410 may receive an optical signal and convert the received optical signal into an analog data. More specifically, the optical signal receiving part 410 may receive an original wavelength signal from the first detection member 310, the reflected wavelength signal from the second detection member 320, and the transmitted wavelength signal from the third detection member 330, such that the received signals are converted into the analog data. In addition, the optical signal receiving part 410 may have a function of adjusting a range of values detected from the detection unit. In addition, it may have a function of tuning a physical signal in order to transmit a signal change to the A/D converting part 420 with high resolution.

The A/D converting part 420 may receive the analog data converted by the optical signal receiving part 410 and convert the same into the digital data according to a sampling period. The sampling period may be set by a user.

The optical signal processing part 430 may detect a wavelength change based on the digital data converted by the A/D converting part 420 and may store the sampled code value. The optical signal processing part 430 may be capable of deriving the reflectivity or transmittance of the substrate on the basis of the data received by the optical signal receiving part 410 and converted by the A/D converting part 420, the wavelength change for which is sampled.

When the signal received by the optical signal receiving part 410 is the original signal wavelength and the reflected signal wavelength, the reflectivity of the substrate may be derived, and when the signal received by the optical signal receiving part 410 is the original signal wavelength and the transmitted signal wavelength, the transmittance of the substrate may be derived. The reflectivity may be derived by comparing the intensity of the incident light and the intensity of the reflected light, and the transmittance may be derived by comparing the intensity of the incident light and the intensity of the transmitted light. That is, the reflectivity may be derived by dividing the detection value of the second detection member 320 by the intensity of the incident light, and the transmittance may be obtained by dividing the detection value of the third detection member 330 by the intensity of the incident light. The intensity of the incident light may be a value already specified as a set value, and may be obtained from the detection value of the first detection member 310.

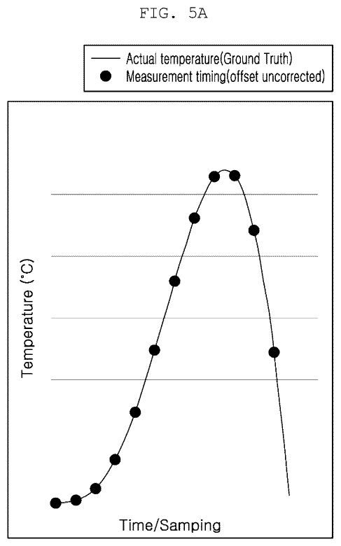

The temperature converting part 440 may convert the wavelength change detected by the optical signal processing part 430 into a temperature value on the basis of the temperature model compared to the wavelength change. The temperature model compared to the optical wave change for the temperature value conversion may be provided from the process part 460. When the optical signal received by the optical signal receiving part 410 is the reflected light, the temperature model compared to the reflectivity may be applied, and when the optical signal received by the optical signal receiving part 410 is the transmitted light, the temperature model compared to the transmittance may be applied. The change in the detection value by the second detection member 320 and the change in the reflectivity derived therefrom may be observed to be linear over time while the substrate (W) is maintained in the solid phase, as shown in FIG. 4. That is, the amount of change in reflectivity may be proportional to the amount of change in temperature while the substrate (W) remains in the solid phase. Accordingly, the relationship between the reflectivity and the temperature may be derived as a linear relationship from the reflectivity detected at the temperature (room temperature) before heating of the substrate (W) and the reflectivity detected at the melting point of the substrate (W). The reflectivity may be calculated by the high-speed signal processing unit 400, the melting point of the substrate (W) may be utilized with a known value according to the material of the substrate (W), and the temperature before heating may be a room temperature or an internal temperature of the chamber set by the user.

The data storage and transceiver part may store and transmit data on the temperature value converted by the temperature converting part 440. The data storage and transceiver part may be provided with a storage medium such as a memory in order to store the temperature data in a nonvolatile memory or transmit the same to other connected systems and users and may include a wireless (e.g., WLAN, BT, etc.) or wired connection (USB, LAN) function. Meanwhile, the data storage part and the data transceiver part may be separately provided.

The process part 460 may be a main processor or a controller circuit for controlling the optical signal receiving part 410, the A/D converting part 420, the optical signal processing part 430, the temperature converting part 440, and the data storage and transceiver part 450, and may be responsible for the signal reception, signal processing, and calculation. In addition, the process part 460 may store in advance a database for the temperature model compared to the optical wave change used in the temperature converting part 440. Alternatively, the training data for the temperature model compared to the optical wave change, machine training and deep learning model may be utilized, and to perform effectively, the process part 460 may include FPGA logic or a co-processor such as a GPGPU or NPU.

Meanwhile, the optical signal received by the optical signal receiving part 410 may further include a heating start signal of the substrate (W) by the heat source 110. At this time, the heating start signal may be transmitted to the high-speed signal processing unit 400 through the channel 3 (ch. 3).

The heating start signal may include information on the timing of wavelength generation of the heat source 110. The temperature change of the substrate (W) caused by the heat source 110 may be predicted by using information on the timing of wavelength generation of the heat source 110. In addition, the heating wavelength signal may be utilized for processing an offset at the measurement time.

The A/D converting part 420 may receive the heating start signal of the heat source 110 from the optical signal receiving part 410 or the process part 460, and then may convert the analog data received through the channel 2 (ch. 2) or the channel 3 (ch. 3) into the digital data according to the timing signal. The data converted into the digital data by the A/D converting part 420 according to the heating start signal may be transmitted as code data to the optical signal processing part through a protocol such as a high-speed signal transmission protocol (e.g., LVDS, JESD204).

The optical signal processing part 430 may provide an offset value reflecting the difference of the measurement time in order to correct the timing of the measurement by receiving the data converted according to the heating start signal, and may set the offset value by identifying information on the trend of the existing temperature change generated through the heating by the heat source 110.

The process part 460 may apply the offset value set by the optical signal processing part 430 to correcting the timing of the temperature measurement for the substrate (W).

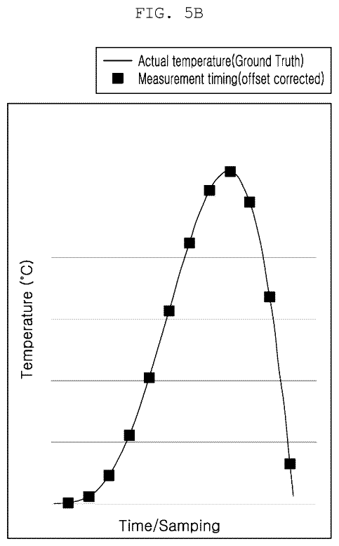

For example, in a case where the high-speed temperature measurement device measures the temperature of the substrate (W) at 1 ns intervals, when the temperature reaches the peak after 30.3 ns after the heat source 110 heats the substrate (W) and departs from the peak point within 1 ns, the high-speed temperature measurement device synchronizing the heat source 110 and the occurrence time may not be capable of identifying the exact peak value because 30 ns and 31 ns points are respectively measured during the 30th and 31st measurements (see FIG. 5A). Therefore, when an offset is set to delay the start of the measurement by 0.3 ns, the 30th measurement value will be at the 30.3 ns point, and the 31st measurement value will be at the 31.3 ns point, such that the measurement can be made at a point closer to the peak (see FIG. 5B).

The high-speed signal processing unit 400 may further include an appropriate driving SW (operating systems, etc.) and a framework for training such that the machine training process proceeds and the calculation using the corresponding model is performed. In this case, the temperature converting part may be separately configured.

In a machine training/deep learning model, a convolutional or recurrent neural network with multiple hidden layers may be constructed, and the activation function of each layer may be configured with various formulas and combinations. In addition, some layers may have dropout processing for weight adjustment.

The input data for training may include information on the changes of a single wavelength or multiple wavelengths transmitted through each channel (ch. 1, ch. 2, ch. 3) connected to the high-speed signal processing unit 400, data normalized with the corresponding information, information on the heating laser, and information on the configuration state of the substrate (W) (previous temperature, the atomic composition and thickness of the substrate).

The output data for training may include a single temperature data or a continuous temperature data at the corresponding point.

Although the above description describes an example of measuring the temperature at 1 point on the substrate (W), the temperatures for multiple points on the substrate (W) may be measured simultaneously depending on mechanical additions or additional configurations of the high-speed signal processing unit 400. Accordingly, it may be possible to modify the input/output data for training and the corresponding model.

The trained model information and weight information may be stored inside the high-speed signal processing unit 400 or in a separate and dedicated calculation device, according to the configuration of the high-speed signal processing unit 400, and the corresponding information may be learned through a self-learning of the high-speed signal processing unit 400 or a database and dedicated system for training, such that the trained information may be received and utilized as packet data or file data.

Training data may be constructed using the trend data generated from a single data or multiple data of the reflectivity and transmittance of the wavelength of the measured light, and it may be possible to progress a supervised learning when a temperature sensor (ground truth) at heights where the actual temperature of the substrate (W) can be measured is available to be utilized and otherwise an unsupervised learning. In the case of an unsupervised learning, it may be possible to provide roughly the temperature label of the data group trained by inversely calculating the heat capacity applied to the substrate (W), such that relative temperature changes or comparisons may be made on the basis of the corresponding information.

The high-speed temperature measurement method using the high-speed temperature measurement device described above may include heating the substrate (W) with the heat source 110, emitting the measured light to the substrate (W) heated by the heat source 110 and providing the original wavelength signal of the measured light to the processing device, receiving the reflected optical signal of the measured light reflected from the substrate and providing the same to the processing device as the reflected wavelength signal, and calculating the temperature change of the substrate caused by the heat source 110 by comparing the original wavelength signal and the reflected wavelength signal. In this case, the processing device may refer to the high-speed signal processing unit 400.

Calculating the temperature change of the substrate may be performed on the basis of the change in the reflectivity of the measured light.

The high-speed temperature measurement method may further include synchronizing the original wavelength signal and the reflected wavelength signal by adjusting the path lengths of the optical wave of the original wavelength signal and the reflected wavelength signal. The synchronizing the original wavelength signal with the reflected wavelength signal may be designed to ensure that the original wavelength signal and the reflected wavelength signal simultaneously reach the high-speed signal processing unit 400.

In addition, the high-speed temperature measurement method may further include providing the heating start signal of the heat source 110 to a high-speed processing unit, and predicting the temperature change of the substrate (W) caused by the heat source 110 by using the heating start signal. It may be possible to improve the accuracy of measuring the temperature by the high-speed temperature measurement device by setting an offset reflecting the difference in the measurement time on the basis of the heating start signal and by applying the set offset to correcting the timing of the temperature measurement.

Meanwhile, the high-speed temperature measurement method may include receiving the transmitted optical signal of the measured light penetrating through the substrate (W) and providing the same as the transmitted wavelength signal to the processing device, and calculating the temperature change of the lower surface of the substrate caused by the heat source 110 by comparing the original wavelength signal and the transmitted wavelength signal. Herein, the processing device may refer to the high-speed signal processing unit 400, and calculating the temperature change of the lower surface of the substrate may be performed on the basis of the change in the transmittance of the measured light.

Hereinafter, a more detailed description may be omitted as it is included in the description of the substrate processing device which includes the high-speed temperature measurement device.

As described above, the substrate processing device including the high-speed temperature measurement device according to the present disclosure may be capable of accurately and quickly deriving the temperature change of the substrate caused by the heat source by using the reflectivity or transmittance. In particular, it may be possible to convert the change in the emissivity into the temperature at a response time of nanoseconds by the high-speed signal processing unit 400, to predict the temperature of the substrate (W) by using the pulse timing of the heat source, and to improve the accuracy of the measurement by the high-speed temperature measurement device by utilizing the offset setting and application for the measurement timing.

Although the present disclosure has been described above, the present disclosure is not limited by the disclosed exemplary embodiments and the accompanying drawings, and may be variously modified by those skilled in the art without departing from the technical idea of the present disclosure. In addition, the technical ideas described in the exemplary embodiments of the present disclosure may be implemented independently or in combination of two or more thereof.

What is claimed is:

1. A high-speed temperature measurement method, the method comprising:
heating a substrate with a heat source;
emitting a measured light to the substrate and providing an original wavelength signal of the measured light to a processing device;
receiving a reflected optical signal of the measured light reflected from the substrate to provide the reflected optical signal to the processing device as a reflected wavelength signal; and
calculating a temperature change of the substrate caused by the heat source by comparing the original wavelength signal and the reflected wavelength signal.

2. The method of claim 1,
wherein the calculating the temperature change of the substrate is performed on the basis of a change in reflectivity of the measured light.

3. The method of claim 2, further comprising:
synchronizing the original wavelength signal and the reflected wavelength signal by adjusting a path length of an optical wave of the original wavelength signal and the reflected wavelength signal.

4. The method of claim 1, further comprising:
providing a heating start signal caused by the heat source to the processing device; and
predicting the temperature change of the substrate caused by the heat source by using the heating start signal.

5. The method of claim 4,
wherein an offset reflecting a difference of a measurement time is set on the basis of the heating start signal, and the set offset is applied to correcting a timing of measuring the temperature of the substrate.

6. The method of claim 1, further comprising:
receiving a transmitted optical signal of the measured light penetrating through the substrate to provide the transmitted optical signal to the processing device as a transmitted wavelength signal; and
calculating a temperature change on a lower surface of the substrate by comparing the original wavelength signal and the transmitted wavelength signal.

7. A high-speed temperature measurement device, the device comprising:
a measurement laser unit for emitting a measured light to a substrate in order to monitor a temperature change of the substrate while the substrate is heated by a heat source;
a detection unit for detecting an optical signal by the measurement laser unit; and
a high-speed signal processing unit for outputting data on the temperature change of the substrate by using the optical signal detected by the detection unit.

8. The device of claim 7,
wherein the high-speed signal processing unit comprises:
an optical signal receiving part for receiving the optical signal and converting the received optical signal into an analog data;
an A/D converting part for converting the analog data into a digital data according to a sampling period;
an optical signal processing part for detecting a wavelength change on the basis of the digital data and storing a sampled code value;
a temperature converting part for converting the wavelength change into a temperature value on the basis of a temperature model compared to an optical wave change;
a data storage and transceiver part for storing and transmitting data on the temperature value; and
a process part for controlling the optical signal receiving part, the A/D converting part, the optical signal processing part, the temperature converting part, and the data storage and transceiver part.

9. The device of claim 8,
wherein the measurement laser unit comprises:
an optical coupler for separating the measured light into a reference light and an incident light; and
an optical circulator for outputting a reflected light of the incident light reflected from the substrate to the detection unit, and
wherein the detection unit comprises:
a first detection member for detecting the reference light of the measured light as an original wavelength signal; and
a second detection member for detecting the reflected light of the incident light reflected from the substrate as a reflected wavelength signal, or a third detection member for detecting a transmitted light of the measured light penetrating through the substrate as a transmitted wavelength signal.

10. The device of claim 9,
wherein the optical signal receiving part receives the original wavelength signal of the measured light, and receives at least one of the reflected wavelength signal and the transmitted wavelength signal of the measured light.

11. The device of claim 10,
wherein the optical signal processing part derives a reflectivity or transmittance of the substrate on the basis of the data received by the optical signal receiving part, and samples a wavelength change for the reflectivity or transmittance of the substrate.

12. The device of claim 11,
wherein the optical signal received by the optical signal receiving part further comprises a heating start signal caused by the heat source.

13. The device of claim 12,
wherein the A/D converting part receives the heating start signal of the heat source and converts the data according to the heating start signal, and
wherein the optical signal processing part sets an offset value for correcting a measurement timing by using the data converted according to the heating start signal.

14. The device of claim 13,
wherein the process part corrects the timing of measuring the temperature of the substrate by applying the offset value.

15. A substrate processing device, the device comprising:
a chamber for providing a processing space;
a substrate support unit for supporting a substrate in the processing space;
a heating unit composed of a heat source for heating the substrate; and
a high-speed temperature measurement device for measuring at high speed a temperature change of the substrate caused by the heat source,
wherein the high-speed temperature measurement device comprises:
a measurement laser unit for emitting a measured light to the substrate in order to monitor the temperature change of the substrate while the heating unit heats the substrate;
a detection unit for detecting an optical signal by the measurement laser unit; and
a high-speed signal processing unit for outputting data on the temperature change of the substrate by using the optical signal detected by the detection unit.

16. The device of claim 15,
wherein the high-speed signal processing unit comprises:
an optical signal receiving part for receiving the optical signal and converting the received optical signal into an analog data;
an A/D converting part for converting the analog data into a digital data according to a sampling period;
an optical signal processing part for detecting a wavelength change on the basis of the digital data and storing a sampled code value;
a temperature converting part for converting the wavelength change into a temperature value on the basis of a temperature model compared to an optical wave change;
a data storage and transceiver part for storing and transmitting the data on the temperature value; and
a process part for controlling the optical signal receiving part, the A/D converting part, the optical signal processing part, the temperature converting part, and the data storage and transceiver part.

17. The device of claim 16,
wherein the measurement laser unit comprises:
an optical coupler for separating the measured light into a reference light and an incident light; and
an optical circulator for outputting a reflected light of the incident light reflected from the substrate to the detection unit, and
wherein the detection unit comprises:
a first detection member for detecting the reference light of the measured light as an original wavelength signal; and
at least one of a second detection member for detecting the reflected light of the incident light reflected from the substrate as a reflected wavelength signal and a third detection member for detecting a transmitted light of the incident light penetrating through the substrate as a transmitted wavelength signal.

18. The device of claim 17,
wherein the optical signal receiving part receives the original wavelength signal of the measured light, and receives at least one of the reflected wavelength signal and the transmitted wavelength signal of the measured light, and
wherein the optical signal processing part derives a reflectivity or transmittance of the substrate on the basis of the data received by the optical signal receiving part, and samples the wavelength change for the reflectivity or transmittance of the substrate.

19. The device of claim 18,
wherein the optical signal received by the optical signal receiving part further comprises a heating start signal of the heat source,
wherein the A/D converting part receives the heating start signal and converts the data according to the heating start signal,
wherein the optical signal processing part sets an offset value for correcting a measurement timing by using the data converted according to the heating start signal, and
wherein the process part corrects a timing of measuring the temperature of the substrate by applying the offset value.

20. The device of claim 16,
wherein the process part obtains a temperature model compared to an optical wave used in the temperature converting part as at least one of a training data, machine learning, and a deep learning model.
